(19) United States
(12) Patent Application Publication
(10) Pub. No.: US 2023/0369944 A1
(43) Pub. Date: Nov. 16, 2023

(54) Centrifugal Pump Comprising a Drive

(71) Applicant: KSB SE & Co. KGaA, Frankenthal (DE)

(72) Inventor: Axel SCHUNK, Frankenthal (DE)

(21) Appl. No.: 18/032,119

(22) PCT Filed: Oct. 5, 2021
(86) PCT No.: PCT/EP2021/077415

§ 371 Date: Apr. 14, 2023

(30) Foreign Application Priority Data
Oct. 16, 2020 (DE) 10 2020 006 365.9

(51) Int. Cl. H02K 9/14; H02K 11/33; H02K 5/20

(52) U.S. Cl. CPC H02K 9/14; H02K 11/33; H02K 5/20

(57) ABSTRACT

A centrifugal pump includes a drive having a fan for generating a first air flow, a motor electronic system which is supported by a heat dissipation arrangement which has at least one opening for the inflow of a second air flow which mixes with at least a portion of the first air flow to enhance cooling of the motor electronic system.

### CROSS REFERENCE TO RELATED APPLICATION

This application claims priority under 35 U.S.C. § 119 from German Patent Application No. 102020006365.9, filed Oct. 16, 2020, the entire disclosure of which is herein expressly incorporated by reference.

### BACKGROUND AND SUMMARY OF THE INVENTION

The invention relates to a centrifugal pump with a drive which has a motor electronics unit which is supported by an arrangement for discharging heat, and a fan for generating a first air stream.

A centrifugal pump arrangement generally comprises one or more centrifugal pumps, one or more electric motors, and electronic equipment for regulating the rotational speed and for inverting the frequency. Especially the electric motors and the associated motor electronics unit require adequate cooling.

Typical electric motors of this type are generally known. The arrangement of the motor electronics unit is often provided on an electronics housing disposed on the motor external wall. Said arrangement of the motor electronics unit generally contains a frequency inverter and a power control system and/or a rotational speed regulating system. Such electronics housings are often disposed on a base so that the heat discharged by the electric motor does not affect the electronics. However, as a result the cooling air stream of the motor no longer adequately reaches the arrangement of the electronics, as a result of which separate cooling of the electronics is often required.

Both radial and axial designs of such cooling systems for electric motors and frequency inverters are generally known. Described in DE 103 39 585 A1 is an axially generated cooling air stream which is deflected with the aid of air-guidance elements in order to cool the radially constructed terminal box. The air-guidance elements can be disposed variably in order to achieve the goal of sufficient cooling. To do this, a technician is needed to adjust the cooling adequately during operation. Furthermore, this invention is constructed from many individual parts, which increases costs and is complex in terms of mounting.

DE 103 62 051 describes an arrangement of a fan for cooling the motor and a power converter, wherein the fan impeller is driven by the motor shaft. The stream of air thus cools the motor and the electronics uniformly. As a whole, the arrangement consists of a plurality of individual parts such as the stator housing with a B bearing flange, fan impeller, evaluation electronics, brake, and magnetizable plastic wheel, as well as a fan cover. As a result, the construction is very complex in terms of mounting, wherein the focus of the invention is primarily on the determination of the position of the fan impeller.

DE 10 2008 051 650 A1 discloses an invention with common cooling of the motor and the motor electronics, in which the air stream is drawn in through the cooling frame of the electronics cooling system before the fan impeller propels the air stream to cool the motor frame. The focus here is on cooling a very large motor electronics unit which is constructed around the motor both axially and radially.

The object of the invention is to configure a device such that an electric motor and its motor electronics unit can be cooled simultaneously with one fan. In order to increase the cooling output, the fan should be able to induct more than one air stream. Furthermore, the component should consist of a thermally conductive material and be able to effectively discharge the resulting heat of both the motor and the motor electronics unit. Moreover, the number of the mechanical interfaces and the seals should be reduced by virtue of the design of the component. Changing replacement parts should be facilitated by the construction of the device. It should be possible for the device to be implemented simply and cost-effectively.

This object is achieved according to the invention by a centrifugal pump with a drive having the features of claim 1. Preferred variants can be found in the dependent claims, the description, and the figures.

The fan of the electric drive of a centrifugal pump advantageously inducts a first air stream centrally by way of a perforated fan cover and in the process generates a first air stream for cooling, the latter flowing over the motor housing and the arrangement for discharging the heat of the motor electronics unit. The construction of the fan cover and the connector of the latter on the motor housing form at least one opening which enables the induction of a second air stream, caused by the first air stream, as a result of which the cooling output of the motor and of the motor electronics unit can be particularly intensified.

According to one preferred variant of the invention, the openings for the inflow of a second air stream are in each case configured as an area, which areas are formed from the delimitation of the arrangement for discharging heat, in the form of the electronics housing base of the motor electronics unit, from the surface-enlarging elements in the form of cooling ribs, and the fan cover.

The cover of the fan is ideally disposed in such a manner that said cover protrudes at least partially into the openings for the inflow of a second air stream, as a result of which a space in the form of a duct for the inflow of the first air stream is formed, said duct opening into a second space in which the first air stream is mixed with the second air stream, the latter, inducted by the suction effect of the first air stream, making its way into this second space. As a result, a particularly intensive air stream is generated, which in the further flow profile discharges the heat of the motor electronics unit and the heat of the electric motor in a particularly efficient manner.

The fan of the electric motor by way of the perforated fan cover inducts a first air stream and drives the latter over the motor housing in order for the electric motor and the motor electronics unit to be cooled. This air stream is in direct contact with the fan and is thus a direct and primary air stream. Ducts are advantageously formed by the arrangement for discharging heat and the cooling ribs of the latter in combination with the motor housing. The first air stream generated by the fan flows through these ducts at a higher pressure than the ambient pressure. A suction by way of the openings for the second air stream is ideally generated by this first air stream. This second air stream, generated by the suction effect of the first air stream, is to be considered indirect.

According to the invention, a fan-proximal bearing cover is connected to an arrangement for discharging heat of the motor electronics unit, in particular of the frequency inverter. This bearing cover has the function of a cover of the motor housing and supports the bearings for mounting the shaft, which can be integrated in a form-fitting and/or force-fitting manner in the bearing cover. The arrangement for discharging heat can preferably be embodied as a cooling member. Apart from the discharge of heat, such a cooling member has the task of supporting the motor electronics unit and is ideally designed as an electronics housing base. The motor electronics unit can be fastened directly or indirectly in such an electronics housing. In an alternative embodiment of the invention, the motor electronics unit can also be attached in a floating manner. The motor electronics unit is preferably disposed so as to bear on the full area and be secured against slipping, because the heat can be discharged in an optimal manner in this way. As a result of the construction of the bearing cover being connected to the cooling member, the cooling of the electric motor and of the motor electronics unit can advantageously be designed with a particularly high output.

In one particularly advantageous variant of the invention, the fan-proximal bearing cover, for example the fan-proximal end bearing cover of the motor housing, is connected to the arrangement for discharging heat. This arrangement by way of example is an electronics housing base for the motor electronics unit and optimized in terms of the design embodiment thereof, including cooling ribs for the discharge of heat of the motor electronics unit, which can comprise a frequency inverter and an output feedback-control and a rotating speed control. Owing to the connected construction, the thermal conduction to the cooled surfaces is improved. Moreover, the cooling air stream generated by the fan can discharge the heat of the electric motor and of the motor electronics unit particularly well by means of the expediently disposed air ducts.

According to the invention, the arrangement for discharging heat is configured so as to be integral to the fan-proximal bearing cover. In the design embodiment of an integral casting, the electronics housing base, having the surface-enlarging elements in the form of cooling ribs molded thereon, and the fan-proximal bearing cover are particularly efficient in terms of the thermal conduction. Moreover, the reduction in terms of the parts to be assembled and the sealing faces as a result of the integral design is particularly assembly friendly. At the same time, the exchange of replacement parts is possible without great complexity.

In a further variant of the invention, the connection of the arrangement for discharging heat to the bearing cover is designed in the form of a threaded connection such that assembly requirements required by the motor geometry can be designed to be assembly friendly.

The electronics housing base, which is designed as the arrangement for discharging heat and for increasing the cooling output has surface-enlarging elements, is particularly advantageous. Said surface-enlarging elements in the form of plate-shaped cooling ribs with an ideally large surface are optimized for dissipating heat and configured so as to be integral to the electronics housing base. The surface of the cooling ribs is sized with a view to the anticipated generation of heat of the motor electronics unit. Moreover, the cooling ribs of the electronics housing are adapted to the shape of the motor housing.

In one preferred variant of the invention the arrangement for discharging heat having cooling ribs molded thereon comprises additional air baffles in combination with recesses which contribute toward increasing the air stream and enable cooling of the motor electronics unit by way of a high output.

According to the invention, the bearing cover, which can be, for example, a fan-proximal bearing cover of the motor housing, has recesses and feedthroughs for cables and plugs. In this way, data communication between the motor electronics unit, in particular the frequency inverter, and the stator winding per se, can be advantageously implemented.

The bearing cover according to the invention of the electric drive, which is configured so as to be integral to the arrangement for discharging heat, can in principle be used for asynchronous motors, for synchronous motors as well as for synchronous reluctance motors.

One preferred variant of the invention is represented by the integral configuration of the fan-proximal motor housing cover and the electronics housing base. The bearing cover having the arrangement for discharging heat can be produced as a casting from a material with a high thermal conductivity, in particular from aluminum. The implementation of the cooling in the form of a fan in combination with optimized ventilation ducts and surface-enlarging cooling ribs with the particularly thermally conductive material aluminum is to be considered to be extremely effective.

The construction of the integral bearing cover and the arrangement for discharging heat advantageously enables the simultaneous cooling of the motor electronics unit and the electric motor. Previously, two separate cooling systems were often used which can now be reduced to one particularly efficient cooling system.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic illustration of a centrifugal pump with a connection element and an electric drive;

FIG. 2 shows a section of an electric drive of a centrifugal pump in accordance with an embodiment of the present invention;

FIG. 3 shows the FIG. 2 electric drive in the perspective side view; and

FIG. 4 shows the FIGS. 2 and 3 bearing cover in the perspective internal view.

### DETAILED DESCRIPTION

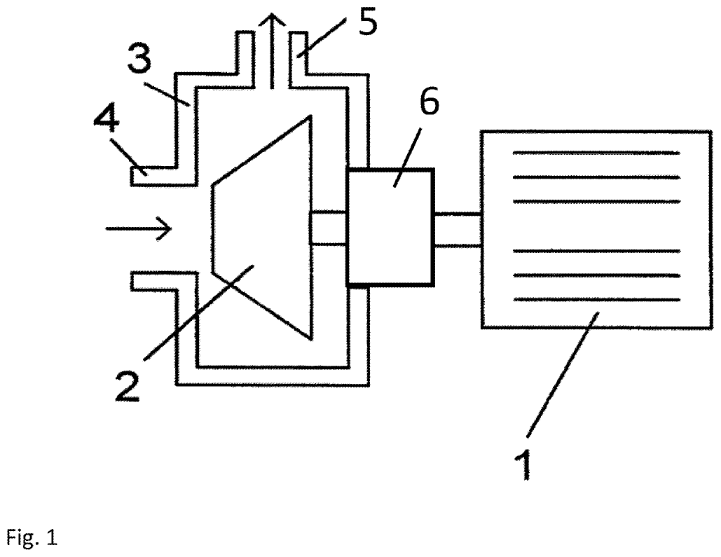

FIG. 1 shows the basic construction of a centrifugal pump which is driven by an electric drive 1 and is equipped with an impeller 2 and a casing 3. The casing 3 has an inlet 4 and an outlet 5. In this exemplary embodiment, a connection element 6 serves to transmit the driving force delivered by the electric drive 1 to the impeller 2. The fluid enters the pump chamber from the left through the inlet 4 and is fed axially to the impeller 2. The rotating impeller 2 transmits kinetic energy to the fluid which has accumulated in the tapering pressure nozzle and leaves the pump chamber at the top via the outlet 5. The connection element 6 is representative of all technically known connecting options between the drive 1 and the pump casing.

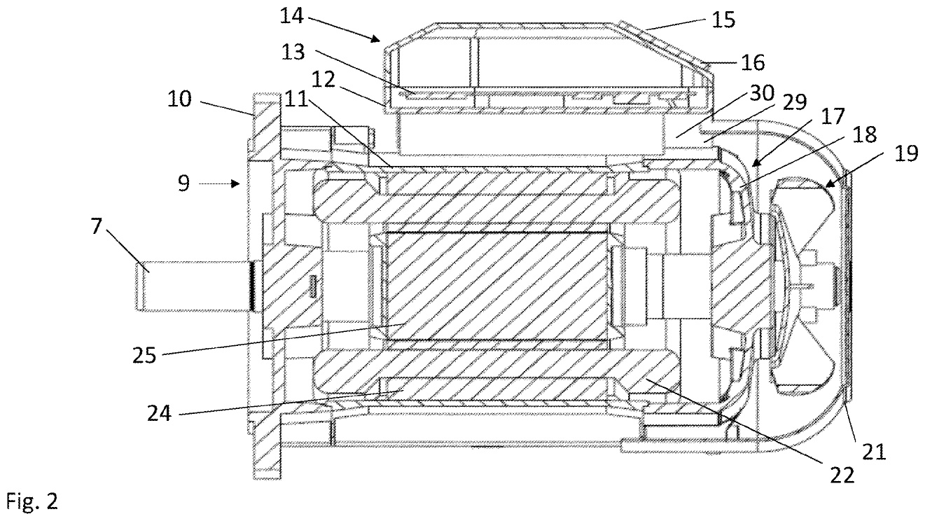

A section of an electric drive 1 of a centrifugal pump is illustrated in FIG. 2. The shaft 7 is supported and mounted by a pump-proximal bearing cover 9 and a fan-proximal bearing cover 17, as a result of which a rotational movement is simultaneously enabled for it. These bearing covers 9, 17 each comprise a bearing carrier 10, 18 into which a rolling bearing is in each case embedded in form-fitting and/or force-fitting manner. At the same time, these bearing covers 9, 17 also serve as a cover of the motor housing 11 and thus close the electric drive 1. The shaft 7 has a rotor 25. The circulating magnetic field in the stator winding 22 induces a magnetic field in the opposite direction in the rotor 25 and consequently sets it in motion. The stator winding 22 is fixed by the stator plates 24.

The motor housing 11 closes, conjointly with the pump-proximal bearing cover 9 and the fan-proximal bearing cover 17, the electric drive 1 and at the same time fixes the stator plates 24. The fan impeller 19, which is connected to the shaft 7, is situated outside the rotor/stator space on the fan-proximal bearing cover 17. The fan cover 21 surrounds the space of the fan 19 and thus prevents unprotected access to the possibly rotating fan impeller. The fan 19 draws an air stream through the center of the perforated fan cover 21 and thus generates a first air stream which, limited by the construction of the fan cover 21 and the bearing cover 17, is guided into an annular duct and flows over the motor housing 11 in order to cool it. The fan cover 21 adjoins the bearing cover 17 in a manner such that, below the arrangement for discharging heat 12, in particular the electronics housing base, a duct 29 is formed, by way of which the first air stream downstream entrains a second air stream, the latter mixing with the first air steam in a larger mixing duct 30. In turn, the cooling of the electric drive 1 and the cooling of the motor electronics unit 14 by way of the arrangement for discharging heat 12, having the cooling ribs molded thereon, is intensified in this way.

In the exemplary embodiment of the invention in FIG. 2, the fan-proximal bearing cover 17 is designed so as to be integral to the arrangement for discharging heat 12. The frequency inverter 13 is disposed and connected in a thermally dissipating manner within the arrangement 12. The arrangement 12 is closed with an electronics housing cover 16 on which an operating unit 15 for operating the motor electronics unit 14 is disposed.

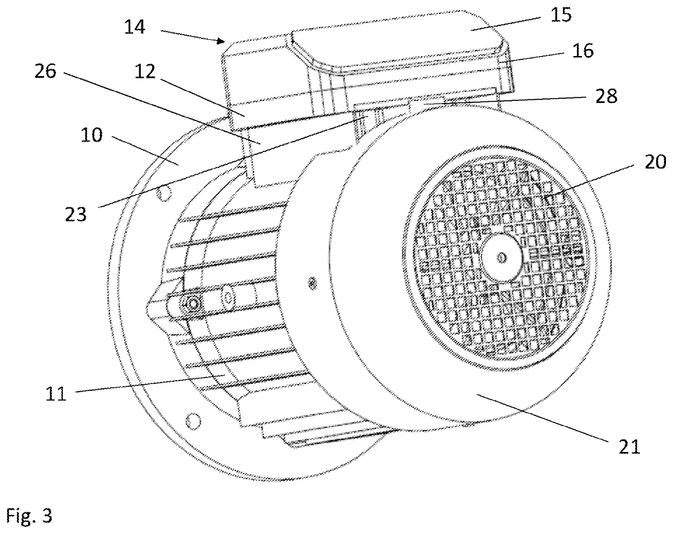

FIG. 3 shows the electric drive 1 in the perspective side view. The motor housing 11 is connected to the bearing carrier 10. The fan cover 21 has openings 20 for inducting a first air stream and forms the termination of the motor housing 11 on the fan-side. The arrangement for discharging heat 12 is configured so as to be integral to the fan-proximal bearing cover 17 (not illustrated) and supports the motor electronics unit 14 which is closed with an electronics housing cover 16 on which the operating unit 15 is attached. The openings 23 for the inflow of a second air stream are disposed between the arrangement for discharging heat 12 and the fan cover 21. The surface-enlarging elements 26, which in this exemplary embodiment are shaped as cooling ribs, conjointly with the fan cover 21 and the arrangement for discharging heat 12 delimit the openings 23 in such a manner that ducts are configured from the spaces for the inflow of the second air stream.

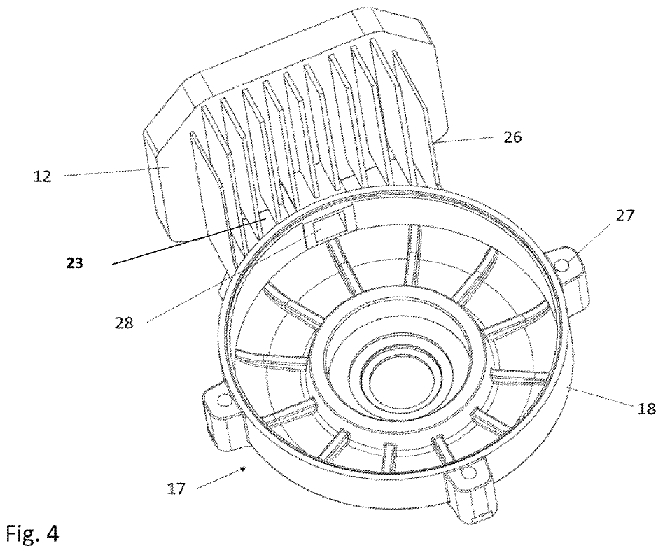

FIG. 4 shows the arrangement for discharging heat 12, which in this exemplary embodiment of the invention is designed so as to be integral to the fan-proximal bearing cover 17, in the perspective internal view. A guide duct 28 is integrated in the transition of the arrangement for discharging heat 12 to the bearing carrier 18 which is configured as the cover of the motor housing 11. As illustrated in FIG. 4, such ducts 28 can be configured as rectangular, round and/or square ducts also being conceivable, however, and can be implemented in the form of a recess inside a casting. One or more elements for connection between the frequency inverter 13 and the stator winding 22 are passed through such a duct 28. The openings 23 for the second air stream are delimited by the arrangement for discharging heat 12, the surface-enlarging elements 26, and the fan cover 21 (not illustrated). The motor housing 11, which is not illustrated in this view and which can be fixed using the fastening element 27, forms the lower side of the delimitations, as a result of which a multiplicity of ducts for the first and the second air stream are configured, said ducts being able to efficiently dissipate the heat of the electric drive 1 as well as of the motor electronics unit 14.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-8. (canceled)

9. A centrifugal pump, comprising:
a drive having a motor electronics unit supported by an arrangement for discharging heat, and a fan for generating a first air stream,
wherein
the fan is configured to generate a first air stream, and
the arrangement for discharging heat has at least one opening configured to for inflow of a second air stream.

10. The centrifugal pump as claimed in claim 9, wherein
the arrangement for discharging heat includes surface-enlarging elements configured for heat exchange with the second air stream.

11. The centrifugal pump as claimed in claim 10, wherein
a cover of the fan has at least one opening configured to induct air of the first air stream.

12. The centrifugal pump as claimed in claim 11, wherein
the cover of the fan extends into the region of the at least one opening such that a space configured to receive at least a portion of the first air stream and a space in which mixing of the first and the second air streams are formed.

13. The centrifugal pump as claimed in claim 12, wherein
the cover of the fan is a fan-proximal bearing cover, and
the arrangement for discharging heat is connected directly to the fan-proximal bearing cover.

14. The centrifugal pump as claimed in claim 13, wherein
the arrangement for discharging heat is integrally formed with the fan-proximal bearing cover.

15. The centrifugal pump as claimed in claim 14, wherein
the surface-enlarging elements of the arrangement for discharging heat are integrally formed with the arrangement for discharging heat.

16. The centrifugal pump as claimed in claim 15, wherein
the fan-proximal bearing cover includes at least one guide duct configured for passing-through of at least one connection between the motor electronics unit and a stator winding of the drive.

17. The centrifugal pump as claimed in claim 13, wherein
the fan-proximal bearing cover includes at least one guide duct configured for passing-through of at least one connection between the motor electronics unit and a stator winding of the drive.
